(19) United States
(12) Patent Application Publication
(10) Pub. No.: US 2008/0215228 A1
(43) Pub. Date: Sep. 4, 2008

(54) Variable Valve Drive For a Reciprocating Internal Combustion Engine

(75) Inventor: Karl Krebber-Hortmann, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHINK GMBH, Aachen (DE)

(21) Appl. No.: 11/994,305

(22) PCT Filed: Jun. 30, 2006
(86) PCT No.: PCT/EP06/06357

§ 371 Date: Dec. 28, 2007

(30) Foreign Application Priority Data
Jul. 1, 2005 (DE) 102005031241.1

(51) Int. Cl. F02D 41/00

(52) U.S. Cl. 701/103; 123/90.15

(57) ABSTRACT

The task of the present invention is to improve a variable valve operating mechanism in order to support different operating ranges of a motor vehicle through optimized operation of the reciprocating internal combustion engine. This task is achieved with a reciprocating internal combustion engine of a motor vehicle with the features of Claim 1, with a method for the cyclical-synchronous switching with the features of Claim 12, and also with a method for operating a reciprocating internal combustion engine of a motor vehicle with the features of Claim 13. Additional advantageous configurations and refinements are specified in each dependent claim.

The present invention relates to a reciprocating internal combustion engine of a motor vehicle with a controller for the cyclical-synchronous switching from spark ignition to controlled compression ignition and vice versa. In addition, a method for the cyclical-synchronous switching from a low to a high residual-gas content and also a method for operating a reciprocating internal combustion engine of a motor vehicle with a cyclical-synchronous switching from spark ignition to controlled compression ignition and vice versa are claimed.

It is known to equip a reciprocating internal combustion engine of a motor vehicle with a variable valve operating mechanism. This is used, in particular, for adapting valve control to the corresponding operating range of the motor vehicle.

The task of the present invention is to improve a variable valve operating mechanism in order to support different operating ranges of a motor vehicle through optimized operation of the reciprocating internal combustion engine.

This task is achieved with a reciprocating internal combustion engine of a motor vehicle with the features of Claim 1, with a method for the cyclical-synchronous switching with the features of Claim 12, and also with a method for operating a reciprocating internal combustion engine of a motor vehicle with the features of Claim 13. Additional advantageous configurations and refinements are specified in each dependent claim.

According to the invention, it is proposed to provide a reciprocating internal combustion engine of a motor vehicle with a controller for the cyclical-synchronous switching from spark ignition to controlled compression ignition and vice versa, wherein a valve group of a cylinder is provided with several intake and exhaust valves and an opening period of the valve group is distributed differently to the intake and/or exhaust valves. Furthermore, a method for the cyclical-synchronous switching from a low to a high residual-gas content with the simultaneous adjustment of an opening time at least of an intake valve and a cylinder charging is provided, wherein an opening period of a valve group of a cylinder with several intake and exhaust valves is distributed differently to the intake and/or exhaust valves of the valve group. Another proposed method for operating a reciprocating internal combustion engine of a motor vehicle provides that a cyclical-synchronous switching from spark ignition to controlled compression ignition and vice versa at least be regulated, wherein an opening period of a valve group of a cylinder with several intake and exhaust valves is distributed differently to the intake and/or exhaust valves of the valve group.

With the proposed reciprocating internal combustion engine, as also with the proposed method, it is allowed, in particular, to be able to provide a combustion method with controlled compression ignition at high exhaust-gas recirculation rates. In this way, a reciprocating internal combustion engine preferably operating according to the Otto principle is brought to compression ignition without the operation of an ignition device, in particular, a spark plug, under the use of high temperatures and also a corresponding pressure. In particular, in this way it can be provided that for the valve group of the cylinder, a valve is controlled normally with a partial load corresponding to the combustion cycle, while another valve is used, in particular, for internal exhaust-gas recirculation. Therefore, this valve has control times that differ from the other valve. In particular, the proposed reciprocating internal combustion engine and also the proposed method allow cyclical-synchronous alternation between a normal operation of a reciprocating internal combustion engine operating according to the Otto principle, in which the ignition mechanism uses an ignition spark, to a compression-ignition operation and vice versa within the scope of a corresponding switching strategy stored in a motor controller. Preferably, controlled compression ignition is performed only above a cooling-water temperature of at least 40° C.

In this connection, reference will be made, as examples, to mechanically variable valve operating mechanisms and also to electromagnetic or electromechanical valve operating mechanisms, which also can be used. These can be used together as well as also separately from each other within the scope of one or more valve groups of one or more cylinders. In addition, variable valve operating mechanisms can also be achieved by means of a camshaft phase adjustment, in particular, assisted thereby. As examples, reference is made within the scope of the disclosure to DE 102 90 017, DE 100 38 917, DE 103 37 430, DE 102 004 005 594, DE 102 004 005 588, DE 100 19 739, DE 101 36 497, DE 197 31 373, DE 100 18 739, and also DE 100 31 233, from which emerge different valve operating mechanisms and arrangements of these valve operating mechanisms, as well as control and regulation devices that can also be used here.

For example, a first design provides a mechanically variable valve operating mechanism. There are several switchable cam profiles for each valve on the exhaust and also on the intake side. Preferably, this is satisfied by means of a configuration of a camshaft in which a second camshaft is arranged. The two shafts can be rotated relative to each other. This relative rotation is preferably such that it comprises a range up to 100° of one cam phase of the camshaft. Preferably, a first phase regulator for an intake camshaft and a second phase regulator for an exhaust camshaft are provided. If a single camshaft is provided for the intake and also the exhaust valves, a single phase regulator can be used. The valves are preferably actuated by means of variable bucket lifters or control levers. In addition, according to one refinement, it is provided that a valve deactivation circuit be provided for individual or else for all valves. With this mechanically variable valve operating mechanism, a variable residual gas or charging control can be achieved. Here, for example, “advanced intake closing” (FES), exhaust port recirculation (AKR) with controlled compression ignition (KSZ) and/or combustion-chamber recirculation (BRR) with controlled compression ignition are realized. This allows, in particular, for a mechanically variable valve operating mechanism to be used for controlled compression ignition, wherein load control can be effected without throttling.

A second design of a mechanically variable valve operating mechanism provides, for example, for a continuous extension of an exhaust event to be realized through a correspondingly controlled partial stroke cam. According to another configuration, it is provided for an additional short exhaust event to be enabled, for example, for a second exhaust valve. Here, for example, there are, in particular, three cam profiles for each valve. Preferably one controller is provided on the intake side as is also provided according to the first design. With the second design, in particular a possible residual gas or charging controller can be enabled, in which, for example, “advanced intake closing” (FES), exhaust port recirculation (AKR) with controlled compression ignition (KSZ), and also combustion-chamber recirculation (BRR) for different partial stroke profiles are provided for a first and a second exhaust valve or combustion chamber recirculation for a valve group in which more than two cam profiles are provided for each valve.

In particular, with the proposed solution an improvement of a partial load efficiency can be achieved for simultaneously reduced low nitrogen oxide emissions for controlled compression ignition of conventional Otto fuels. Through internal exhaust-gas recirculation, compression ignition can be realized at several locations within the combustion chamber of the internal combustion engine of the motor vehicle. With an opening period of the valve group, especially a valve overlap, which is distributed differently to the intake and/or exhaust valves, cylinder charging can be controlled in interaction with a residual gas portion and also the air ratio can be controlled, so that a spatial distribution of the fuel-air mixture in the combustion chamber is realized to enable a fast, non-knocking reaction. In particular, this allows a burn rate with compression ignition of the Otto fuel being used that approaches ideal constant-volume combustion.

According to one refinement, it is provided that switching from conventional operation of the reciprocating internal combustion engine in the Otto process using spark ignition to a homogenous charge compression ignition is realized not only in a cyclical-synchronous way, but also in a cylinder-selective way. Preferably, it is provided for homogenous charge compression ignition to be applied only in a partial load range. In this range, high residual-gas content can be set, which allows for homogenous charge compression ignition. At higher load demands, the engine is switched to spark ignition.

Another configuration provides for the engine to be switched from spark-ignition operation to compression-ignition operation of the reciprocating internal combustion engine only when the reciprocating internal combustion engine has a predefined temperature range, in particular, a certain engine temperature. Here it is provided for the temperature to be measured either directly or indirectly at the reciprocating internal combustion engine. This can be realized, for example, by means of a temperature sensor in the vicinity of the combustion chamber, as also by means of a temperature sensor in the exhaust gas flow.

For achieving a high temperature in the combustion chamber for the homogenous charge compression ignition, internal exhaust-gas recirculation is preferably provided in which residual gas is retained in the combustion chamber in a range of at least 20% to 80%. This can be achieved, for example, through a short opening period of the exhaust valve or valves. This is in particular carried out in a range of low loading. Here, it is provided that after a compression of the residual gas and successful pressure equalization during the expansion, only a quick valve opening of the intake valve or valves is effected in which a fresh air-fuel mixture or air is drawn in. In contrast, in a high load range, residual gas that has already been pushed out due to an exhaust valve opened past top dead center is drawn back into the combustion chamber by means of an exhaust port recirculation. According to one refinement, it can also be provided that one or more exhaust valves are closed at top dead center and residual gas is drawn through a new opening by at least one exhaust valve in a downward phase of the piston. In particular, a combination of these variants can also be realized.

According to another configuration, for a valve overlap an opening period of the valve group is distributed differently to the intake and/or exhaust valves. Preferably, the intake valves of the valve group each have a different opening period. This can change over the different load ranges. There is also the possibility that the exhaust valves of the valve group each have a different opening period. This can also be set differently in different load ranges. According to one configuration, an opening time of a first intake valve of the valve group differs from an opening time of a second intake valve for the valve group and an opening time of a first exhaust valve of the valve group differs from an opening time of a second exhaust valve for the valve group. In this way, it is in particular enabled to allow a desired recirculation of the pushed-out residual gas, as also a fresh mixture supply into the combustion chamber. For example, it is provided that the first exhaust valve and/or the first intake valve of the valve group are integrated in a switchable way into an internal exhaust-gas recirculation strategy, while the second exhaust valve and/or the second intake valve is linked to a normal combustion cycle according to the Otto principle. Thus, in a first load range, the first as also the second intake or exhaust valve can be switched synchronously. In certain load ranges, however, especially for a cyclical-synchronous switching from spark ignition to controlled compression ignition, the switching cycles and thus the opening periods of the different exhaust or intake valves diverge. Here, it is preferably guaranteed that at least the second exhaust valve and/or the second intake valve be opened or closed accordingly at the required combustion cycle.

To prevent setting up intermediate states during switching from spark ignition to controlled compression ignition and vice versa, wherein combustion can fail due to the non-controllability of the intermediate states, a cylinder-synchronous switching of the cams is important. For example, an adjustable speed of the intake or exhaust valves is also important. Here, the goal is to achieve the fastest possible opening and closing of large cross sections at the valves. Here, for example, an exhaust cam is to be provided, so that complete valve openness exists in order to allow a maximum stroke beyond a maximum dead center of the piston. For example, for fast opening or closing, an effective opening period of a valve group can be distributed to several intake or exhaust valves. Thus, according to one configuration, it is provided for the use of an outer camshaft with an inner shaft that a first cam profile is associated with the outer shaft. In contrast, several other cam profiles are associated with the inner shaft and can be rotated relative to the outer-lying shaft. This changed opening period can be further supported in that for each valve of a cylinder, switching elements can be provided that can completely deactivate the valve and can also activate different kinematics, for example, through different cam profiles. Thus, for example, a changed residual-gas content in the combustion chamber or an effect on the cylinder charging in the combustion chamber is possible.

For a rocker arm, for example, two or three different cam profiles can act on a valve by means of a roller rocker arm. This allows a continuous extension of a basic event like opening of this valve. For this purpose, for example, a conventional basic profile with a large stroke is provided on an outer-lying camshaft. In contrast, a profile with a reduced stroke is arranged in an inner-lying camshaft, which can lie completely in a cavity of the outer profile. Through appropriate rotation, now an extension of the full-stroke event with the reduced stroke can be allowed. The reduced stroke lies, for example, in a range between 40% and 50% of the large cam stroke. In particular, for the large cam stroke and thus for the full-stroke cam there is a ramp that transitions to the cam reduced in profile. In this way, the speed of an intermediate arm in the valve operating mechanism is reduced. In addition, this also allows the rocker arm for one cam profile to be relocated to the other profile with low noise.

A camshaft with inner-lying and outer-lying shafts is enabled, for example, such that the cams are produced from bar stock. The cams produced in this way are then pressed onto a camshaft and/or connected with a positive fit. According to one configuration, it is provided here that for each valve there are two fixed cam profiles, with the first valve being activated for KSZ operation.

A cyclical-synchronous switching is configured, for example, such that at least one cycle is operated during at least two crankshaft rotations for controlled compression ignition, while at least one second cylinder is ignited by sparks during the same time period. According to another configuration, a first and a second cylinder are switched simultaneously during a few crankshaft rotations. Preferably, in these configurations it is also provided that during switching all of the valves of a valve group are deactivated apart from an exhaust valve and at least one intake valve in each group.

An especially fuel-saving operation is set when for a low load, especially in BRR operation between 0% to 60%, preferably between 20% to 40% of a nominal load, residual gas in an amount of at least 20% to approximately 80%, especially at least 40% of the volume generated in a combustion process, is retained through a shortened opening period of at least one exhaust valve in the combustion chamber. Here, 0% is understood to be idling of the internal combustion engine. Another configuration provides that especially in an AKR operation at a high load in a range between 20% and 80% or between 75% and 100% of a nominal load*, an opening period of an exhaust valve is adapted such that residual gas pushed out from the combustion chamber is drawn back in. Preferably, it can result in an overlap of an exhaust event with an intake event. *[Editor's note: In the restatement of this passage in Claim 19 the lower range is from 0% and 80% of a nominal load; in either case this “high load” range substantially duplicates the “low load” ranges described earlier in the paragraph.]

The following table shows a switching strategy in an example configuration for a reciprocating internal combustion engine that is operated according to the Otto principle. The first table shows how, for a four-valve engine, starting with spark ignition (SI), the exhaust valves or the intake valves are switched until controlled compression ignition (KSZ) has been set. This is specified in the column with the heading “Mode.” In the “Cycle” column an adjustment relative to the crankshaft rotation is specified. In the starting position cycle=0, all of the intake and exhaust valves are activated and each have their full stroke. At this time, the demand is set on the part of an engine controller due to a special operating range being reached, such that controlled compression ignition (KSZ) with exhaust port recirculation (AKR) is to be set. Due to this situation, cycle 1 leads to valve deactivation. Here, an exhaust valve and also an intake valve are deactivated. In cycle 2, according to this example, a camshaft rotation is performed. This is designated as “phasing intake/exhaust NW [camshaft].” Here, the activated valves remain in their corresponding positions, while the camshaft assigned to the deactivated valves rotates into its predetermined phase position for exhaust port recirculation. This phase can also run, for example, in the third cycle, while in the fourth cycle, the actual switching to the controlled compression ignition is performed. Here, in particular, enough residual gas is drawn back into the combustion chamber by means of exhaust port recirculation that preferably multiple ignitions are enabled in the combustion chamber itself. Here, for example, the deactivated exhaust valve is actuated with reduced stroke, wherein the exhaust valve closes late. In contrast, the first intake valve, which was previously activated with full stroke, is deactivated, while the second intake valve is activated again, but is switched to only a partial stroke. The second intake valve is preferably adjusted toward a retarded position. As can also be inferred from the first table, the actual switching takes place at a time at which relative rotation of two camshafts supported one inside the other has been completed. This allows the cyclical-synchronous switching from spark ignition to controlled compression ignition and vice versa. The latter emerges from the second table, which is placed after the first table. For example, an adjustment speed of a phase regulator with approximately 100 to 200°KW [of the crankshaft]/s can be performed.

| | | Exhaust valves | | Intake valves | | |
|---|---|---|---|---|---|---|
| Cycle | | 1 | 2 | 1 | 2 | Mode |
| 0 | Requirement KSZ with | Full stroke | Full stroke | Full stroke | Full stroke | SI |
| | AKR | | | | | |
| 1 | Valve deactivation | Full stroke | Deactivated | Full stroke | Deactivated | SI |
| 2 | Phasing intake/exhaust | Full stroke | Deactivated | Full stroke | Deactivated | SI |
| | NW | | | | | |
| 3 | Phasing intake/exhaust | Full stroke | Deactivated | Full stroke | Deactivated | SI |
| | NW | | | | | |
| 4 | Switching -> AKR | Full stroke | Partial stroke, late | Deactivated | Partial stroke, late | KSZ |

| | | Exhaust valves | | Intake valves | | |
|---|---|---|---|---|---|---|
| Cycle | | 1 | 2 | 1 | 2 | Mode |
| 0 | AKR | Full stroke | Partial stroke, late | Deactivated | Partial stroke, late | KSZ |
| 1 | Valve deactivation and | Full stroke | Deactivated | Full stroke | Deactivated | SI |
| | SI | | | | | |
| 2 | Phasing intake/exhaust | Full stroke | Deactivated | Full stroke | Deactivated | SI |
| | NW | | | | | |
| 3 | Phasing intake/exhaust | Full stroke | Deactivated | Full stroke | Deactivated | SI |
| | NW | | | | | |
| 4 | Valve activation | Full stroke | Full stroke | Full stroke | Full stroke | SI |

Other advantageous configurations and refinements are explained in more detail in the following drawings. The features shown and described there, however, are not limited to the individual configurations. Instead, these can be combined with other features and configurations from the drawings or from the above description of the refinement. Shown are:

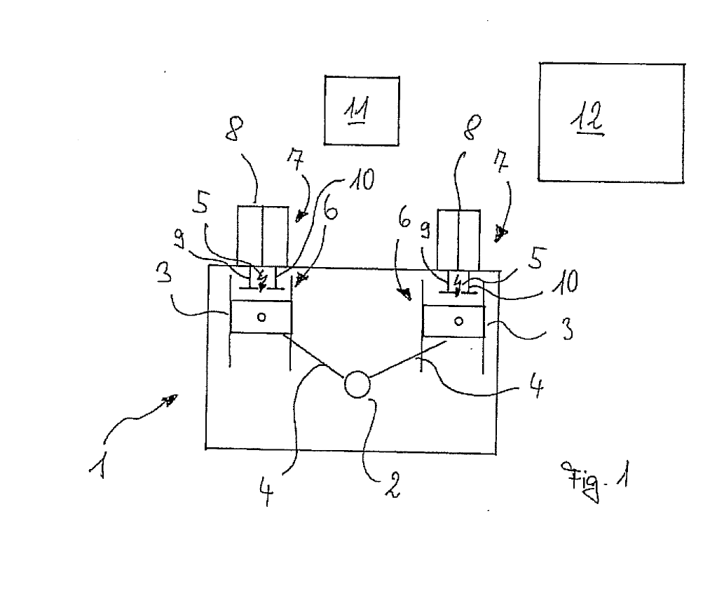

FIG. 1, a basic block diagram of an internal combustion engine in schematic view,

FIG. 2, a multiple-part first camshaft,

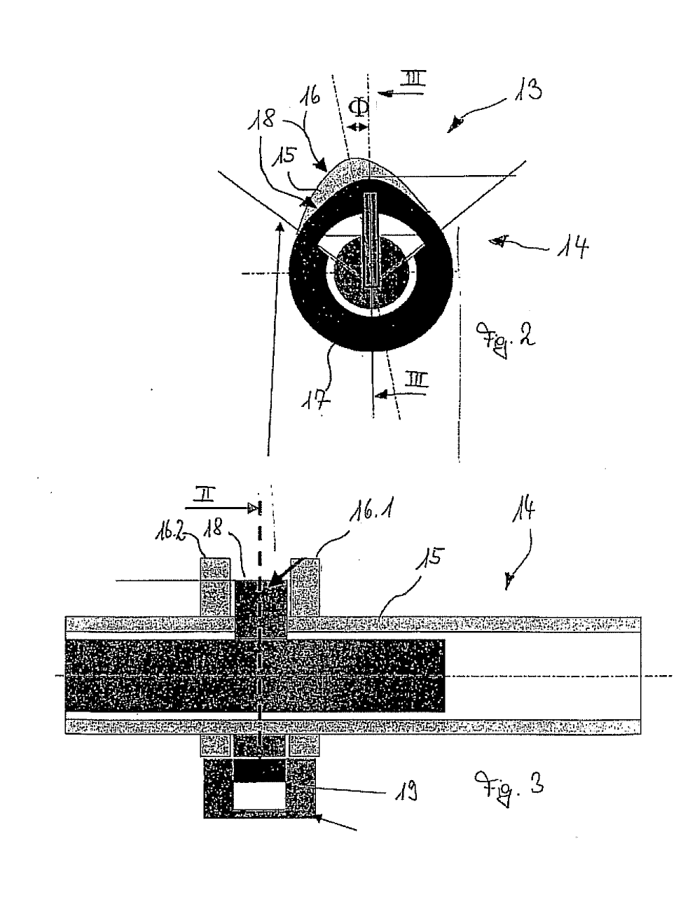

FIG. 3, a longitudinal section through the camshaft from FIG. 2,

FIG. 4, a second camshaft,

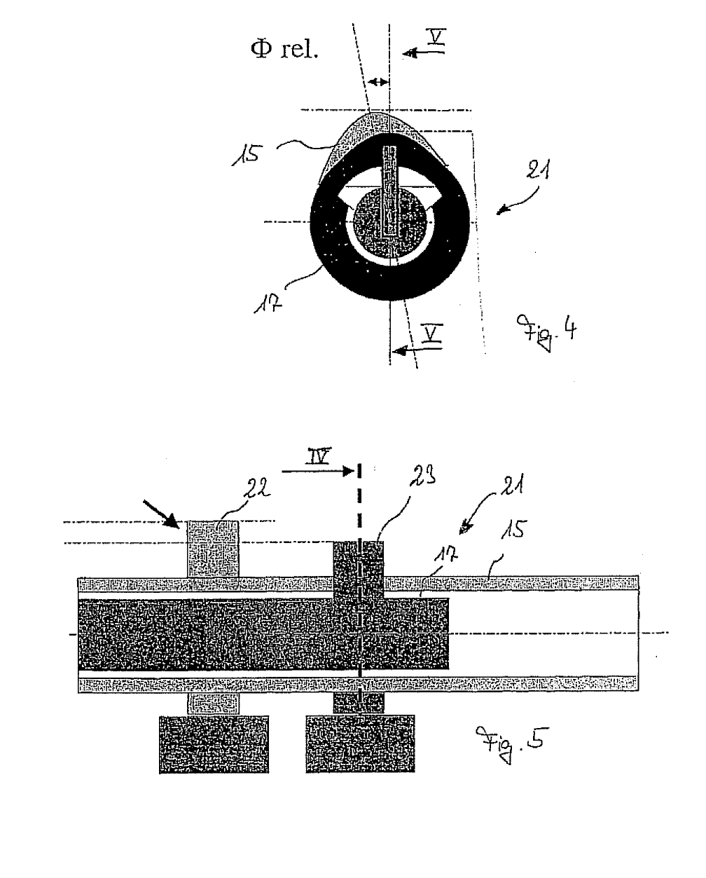

FIG. 5, a longitudinal section through the camshaft from FIG. 4,

FIG. 6, a schematic view of an advanced-intake closing (FES),

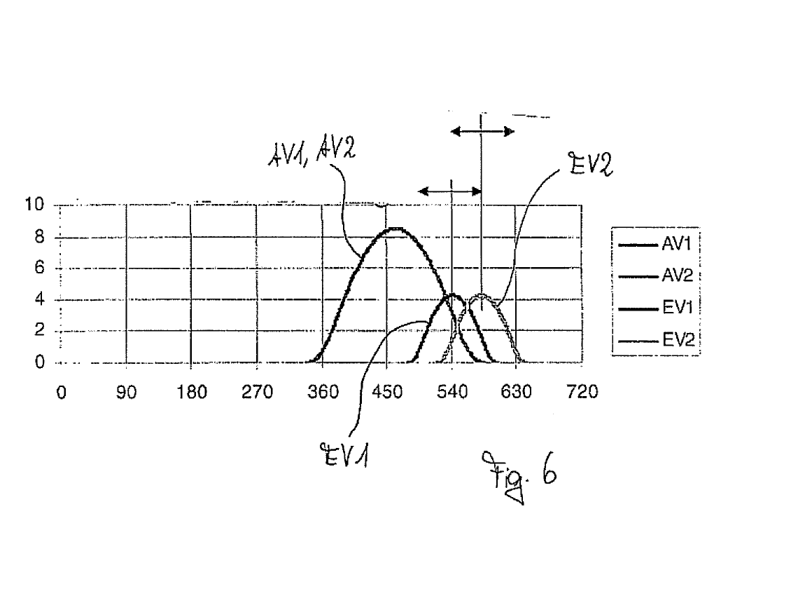

FIG. 7, control times for a second exhaust valve and a first intake valve for low load and combustion chamber recirculation,

FIG. 8, a schematic view of control times for a first and a second exhaust valve and also a first intake valve in a high load range with exhaust port recirculation,

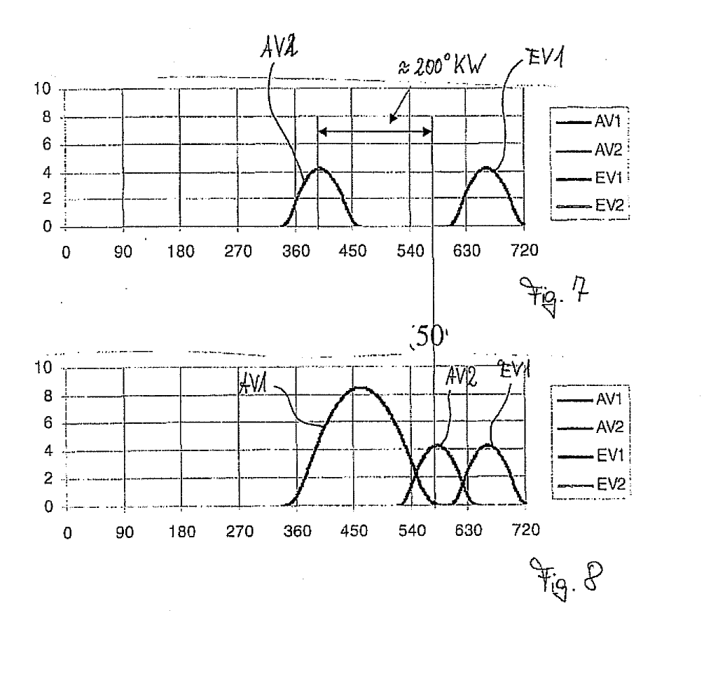

FIG. 9, a schematic view of a cylinder with intake and exhaust valves in a top view,

FIG. 10, a switching strategy for the first exhaust valve and the first intake valve for the exhaust port recirculation,

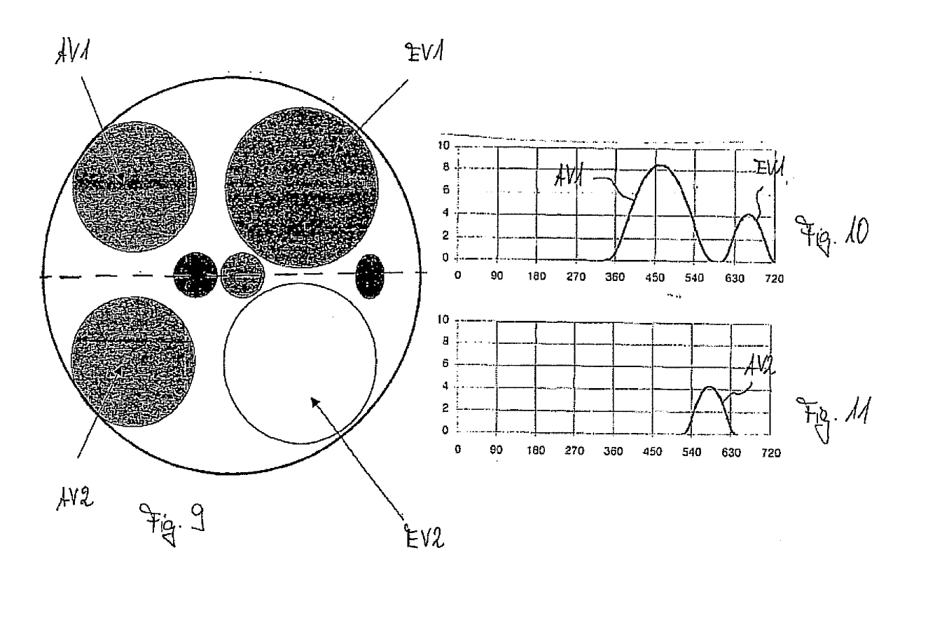

FIG. 11, a switching strategy for the second exhaust valve for converting the exhaust port recirculation,

FIG. 12, a switchable rocker arm for two cam profiles in schematic view, in particular for a continuously variable discharge event,

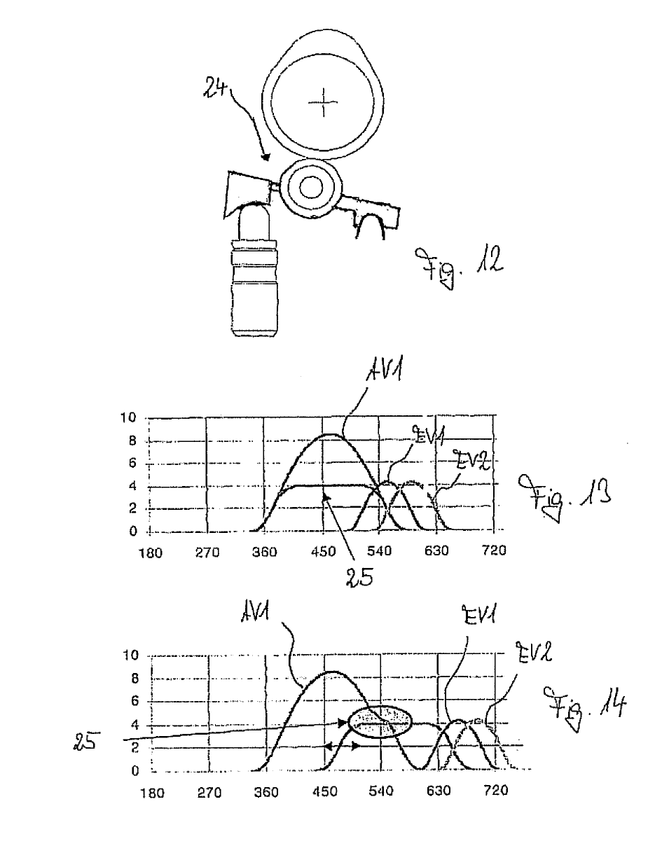

FIG. 13, a schematic view of control times for an advanced intake closing (FES) operation,

FIG. 14, a schematic view of valve control times for an operation of the internal combustion engine with controlled compression ignition (KSZ) with exhaust port recirculation (AKR),

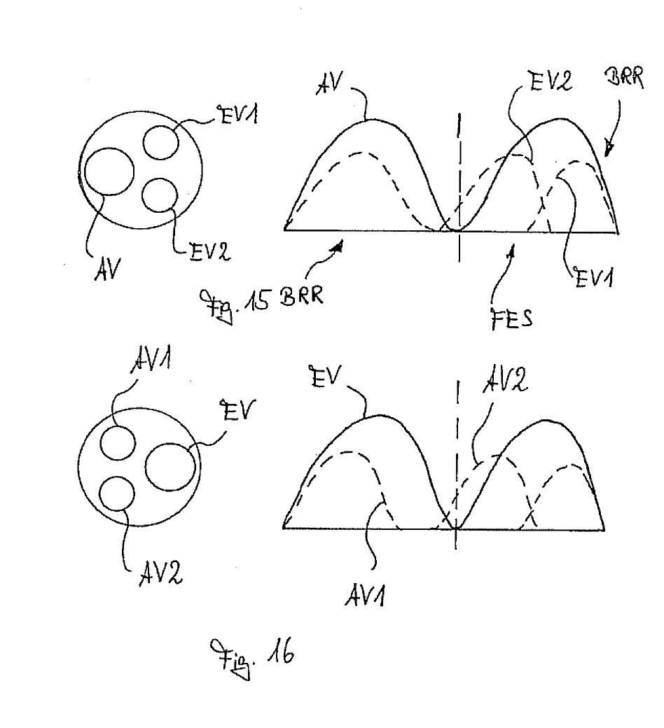

FIG. 15, a schematic view of a first functional sketch for a 3-valve system, and

FIG. 16, a schematic view of a second functional sketch for a 3-valve system.

In a schematic view, FIG. 1 shows a reciprocating internal combustion engine 1 of a motor vehicle, which operates, for example, according to the Otto principle. Several pistons 3 are connected to a crankshaft 2 via connecting rods 4. Here, the reciprocating internal combustion engine 1 can be constructed as an inline engine, a boxer engine, a VR engine, or also as a V engine. Various valve designs can be implemented for each cylinder preferably four and more valves per cylinder. However, a three-valve design for each cylinder can also be implemented. Implementation of the BRR principle can also be realized for a two-valve design. By means of an ignition device 5, spark ignition is initiated in the combustion chamber, which is not shown in more detail and which is respectively formed by the relevant piston 3 and the walls of the cylinder and the cylinder head, lying above this piston. Here, a valve operating mechanism 7 with a valve group 8 is assigned to each cylinder 6. The valve operating mechanism can be of a mechanical, electromagnetic, and/or electromechanical nature. The valve group 8 comprises, in turn, at least two intake valves 9 and two exhaust valves 10. The intake valves 9 and also the exhaust valves 10 can be at least partially adjusted with respect to their opening period by means of a controller 11. The controller 11 is preferably a control device for the valve operating mechanism 7. The controller 11 is also preferably connected to an engine controller 12. This can receive signals coming from the crankshaft, evaluate these signals, and transmit corresponding signals to the controller 11. In this way there is the possibility of synchronizing a motion sequence of the valves 9, 10 in interaction with the crankshaft 2, so that a cyclical-synchronous switching from spark ignition to controlled compression ignition and vice versa is allowed. Preferably, at least the controller 11 is coupled with the engine controller 12 via a CAN bus system. In particular, other signals for the controller 11 or for the engine controller 12 can also be transmitted via the CAN bus. This allows a large data bandwidth and also fast transfer, which can be used especially advantageously in terms of the cyclical-synchronous switching. Furthermore, however, other bus systems can also be used that provide comparable data-transmission possibilities. The engine controller 12 and/or the controller 11 can have one or more engine characteristic maps. Desired values can be determined from these engine characteristic maps that can be used for controlling or regulating individual valves 9, 10. In particular, there is the possibility of enabling regulation or control of the desired opening period of the valves 9, 10 by means of a corresponding position mapping of one or more valves. Here, for example, the controller 11 and/or the engine controller 12 can also provide a suitable timer circuit. In addition to a trajectory controller or a regulator placed on a trajectory controller, there is also the possibility of providing an adaptive regulator in order to distribute an opening period of the valve group 7 differently to the intake or exhaust valves 9, 10.

FIG. 2 shows a first example for a mechanical switching element 13. The mechanical switching element 13 is a component of a mechanically variable valve operating mechanism, which can be actuated by means of a variable bucket lifter or a switching lever. For this purpose, the shown camshaft 14 has an outer shaft 15 with an outer cam profile 16 and an inner shaft 17 with an inner cam profile 18. The inner shaft 17 is supported so that it can rotate in the interior of the outer shaft 15. Preferably, an adjustment range has a range of at least 150° of the crankshaft. Preferably, the adjustable range equals at least 200° of the crankshaft. In this way, there is a relative phase shift Φ in a range between 0 and 100° of the camshaft.

FIG. 3 shows a longitudinal section through the mechanical switching element 13 from FIG. 2. According to this example, the outer shaft 15 is a component of a multiple-part camshaft 14. Two outer cam profiles 16.1, 16.2 here sandwich the inner cam profile 18. The outer cam profiles 16.1, 16.2 form full-stroke cams, while the inner cam profile 18 forms a partial stroke cam. By means of a switching device 19, force can act on a transmission element 20. According to the position of the switching device 19, lie outer cam profile 16 or else the inner cam profile 18 acts on the transmission element 20. If the switching device 19 is locked, for example, and the camshaft 14 has a phase shift, on the one band the outer cam profile 16, but also the inner cam profile 18, transfers corresponding kinematics to the valve, not shown in more detail, via the transmission element 20. The valve is opened or closed according to these kinematics. The transmission element 20 can here be, for example, a rocker arm or a bucket tappet.

FIG. 4 shows a second camshaft 21, which is also a component of a mechanically variable valve operating mechanism. This also has a relative phase shift between an outer shaft 15 and an inner shaft 17. Preferably, the adjustment range here can also be on the order of magnitude of 200° KW, so that a relative phase shift can be set in a range between 0 and 100°. The second camshaft 21 has a configuration that is different relative to the first camshaft from FIG. 2, and this emerges in more detail from the subsequent figure.

FIG. 5 shows a longitudinal section through the second camshaft 21 from FIG. 4. Here, the second camshaft 21 on the outer shaft 15 has a full-stroke cam 22 for a first valve and a partial-stroke cam 23 for a second valve. The inner shaft 17 here can shift or rotate relative to the outer shaft 15. Such a mechanical switching element can be used, for example, as a phase regulator for engines with a camshaft. In addition, through the use of rocker arms, which actuate both valves, they are switched from full stroke to partial stroke. This configuration of a mechanical switching element thus works without a variable bucket lifter or switching device.

FIG. 6 shows as an example a valve controller for, in particular, the various types of valve drives specified above, in order to allow “advanced intake closing” (FES). Here, a valve stroke is specified in millimeters on the Y-axis. On the X-axis a crank angle is specified in crankshaft° after bottom dead center. Two intake valves AV1, AV2 are opened in sync and closed in sync in a range that includes at least 360° to 540° KW. The two exhaust valves AV1, AV2 are here switched to full stroke. Furthermore, a first intake valve EV1 and a second intake valve EV2 are each characterized with corresponding motion curves. Both intake valves EV1 and EV2 are here switched to partial stroke. Here, partial stroke preferably means that the valve stroke is at least 30% less than the full stroke, especially in a range between 40% and 60% of the full stroke. While the first intake valve EV1 is opened preferably in a range between 450° KW and 540° KW, the second intake valve EV2 is advantageously opened in a range between 510° KW and 580° KW. The corresponding opening times are shifted relative to each other. By means of controlling, in the first instance the opening time or the closing time of the first intake valve EV1, residual gas control can be performed in interaction with an adapted opening or closing of the exhaust valves AV1, AV2. In particular, for this purpose the opening period of the first intake valve EV1 can be shifted as indicated by the arrow. By shifting the opening and closing times of the second intake valve EV2, there is also the possibility to realize control of charging the combustion chamber with fresh air. In this way, for a valve group overall there results an opening period that is distributed differently to the intake valves in this case.

FIGS. 7 and 8 specify the control times with which controlled compression ignition can be performed, using an example for an Otto engine with two intake valves and two exhaust valves.

FIG. 7 shows control times in a schematic view, wherein a valve stroke in millimeters is plotted on the Y-axis, while a crankshaft angle after lower dead point is plotted on the X-axis. The opening period is set up by means of control of the second exhaust valve AV2 and the first intake valve EV1. The first exhaust valve AV1 and also the second intake valve EV2 are each deactivated. An opening range of the second exhaust valve AV2 here includes a range between 360° KW and 430° KW. In contrast, an opening range of the first intake valve EV1 includes at least a range from 630° KW to 700° KW. Both opening periods, however, can also be shifted around these ranges. The combustion chamber recirculation means that by means of the short opening period of the exhaust valve or valves, a high proportion of residual gas can be retained in the cylinder. In contrast, the intake valve is opened only briefly, so that only a small fresh fuel-air mixture or air can flow in relative to other operating conditions of the Otto engine. The combustion chamber recirculation is enabled, in particular, at a low load.

FIG. 8 shows another configuration of control times for achieving controlled compression ignition of an Otto internal combustion engine. Here, a principle of exhaust port recirculation is used. In FIG. 8, the valve stroke is again specified on the Y-axis in millimeters, while the crank angle is again specified on the X-axis in crankshaft° after bottom dead center. In contrast to combustion chamber recirculation from FIG. 7, the load range in which exhaust port recirculation according to FIG. 8 is executed is higher. For this purpose, for example, the opening period of the first intake valve EV1 remains unchanged. In contrast, however, the opening time period of the second exhaust valve AV2 changes. This is allowed, for example, through an adjustment range of a camshaft, as was described above. As inferred from FIG. 8, an adjustment is realized by ca. 200° KW. In addition to the second exhaust valve AV2, now the first exhaust valve AV1 is also activated. The latter has a full stroke, while the second exhaust valve AV2 and the first intake valve EV1 are each operated only in a partial stroke. Preferably, the partial stroke equals between 40% and 60% of a full stroke. In this exhaust port recirculation, a valve overlap between the intake and exhaust valves arises, preferably only between the second exhaust valve AV2 and the first intake valve EV1, but not between the first exhaust valve AV1 and the first intake valve EV1.

FIGS. 9, 10, and 11 illustrate, in turn, the switching strategy for a selected cylinder that has a valve operating mechanism with four valves. While FIG. 9 gives a schematic view of the cylinder with the individual valves and additional components, FIG. 10 shows the opening period of the first exhaust valve AV1 and the first intake valve EV1, which in FIG. 9 are assigned [sic; positioned] adjacent to each other on one half. FIG. 11 shows, in turn, the opening period of the second exhaust valve AV2, which is arranged in the other half in FIG. 9. The two halves in FIG. 9 are illustrated by the dashed line. The first exhaust valve AV1 can be acted upon with a full stroke by means of the valve operating mechanism. In particular, the first exhaust valve AV1 can be deactivated. In contrast, the first intake valve EV1 can be switched to a full stroke and also to a partial stroke by means of the valve operating mechanism. In addition, it can also be deactivated. The second exhaust valve AV2, in turn, can be acted upon with a full stroke and also with a partial stroke by means of the valve operating mechanism. The second intake valve EV2, on the one hand, can also be deactivated and on the other hand, can be acted upon with a fall stroke or partial stroke by means of the valve operating mechanism. If a valve group of a cylinder satisfies this system requirement, then there is the possibility of exhaust port recirculation, as emerges from FIG. 8 and as was illustrated split in FIGS. 10 and 11 with the corresponding control.

FIG. 12 shows, in an example configuration, a mechanical adjustability enabled by means of a switchable rocker arm 24 for two cam profiles. According to the adjustable position of the rocker arm 24, a full stroke and also a partial stroke can be set. For this purpose, the camshaft has two different camshaft outer contours, wherein the adjustability is produced, for example, through different exhaust contours of the switchable rocker arm 24. In particular, the rocker arm 24 can be switched, so that a continuously variable opening range is produced for each activated valve.

FIG. 13 shows, in an example configuration, the control times for an “advanced intake closing” operation with a mechanical switching element, as emerges, for example, from FIG. 12. Here, the first and the second intake valves EV1, EV2 are each opened or closed at different times, so that an opening period of the valve group is produced that is distributed to the individual intake valves. In addition, the first exhaust valve AV1 is acted upon with a full stroke. Here, the cam contours are preferably used on an outer shaft of the camshaft. The travel path 25 is also shown that would have been initiated by means of a partial stroke cam on the first exhaust valve AV1, if this were activated. However, because the partial stroke cam is located in a position in which the first exhaust valve AV1 is controlled by means of the full stroke cam, the opening or closing of the first exhaust valve AV1 is not changed. Such a change, however, is possible, for example, through the phase shift of the inner shaft and the outer shaft of the camshaft. In addition, by switching, for example, the switchable rocker arm in FIG. 12, a continuous change of the opening period and the opening stroke of the first exhaust valve AV1 can be set.

FIG. 14 specifies, in a schematic view, the control times for continuous compression-ignition operation with exhaust port recirculation, as can be achieved, for example, with a device according to FIG. 12. Relative to FIG. 13, the opening times of the first and second intake valves EV1, EV2 are each shifted by at least 100° KW. In particular, the opening times of both intake valves can be shifted relative to each other. In addition, the exhaust valve AV1 is on the one hand activated with the full stroke cam, and on the other hand, with the partial stroke cam. A possible adjustment range of die partial stroke cam is indicated by the double-sided arrow. Between the full-stroke cam and the partial-stroke cam there is a ramp 25, which is circled. By means of the ramp 25, a cam follower is moved from the full stroke cam to the partial stroke cam, without the cam follower being lifted from the camshaft. The ramp 25 is constructed such that contact with the cam follower remains guaranteed over the entire adjustment range of the partial stroke cam relative to the full stroke cam. Whereas in comparison with FIG. 13 the full stroke cam is constructed nearly unchanged relative to the opening time period, the operation of the partial stroke cam enables recirculation of residual gas flowing from the cylinder into an exhaust channel back into the combustion chamber. Through an overlap of the opening time period of the first exhaust valve AV1 with the opening times of the first and second intake valves EV1, EV2, the combination required for a high load range produces on die one hand a high temperature in the combustion chamber itself due to the recirculated residual gas, and also a sufficient air flow supply, which can both be mixed together with each other due to the valve overlap.

FIG. 15 shows, in a schematic view, a schematic for a 3-valve system on a cylinder with an exhaust valve AV, a first intake valve EV1, and a second intake valve EV2. The arrangement of the valves relative to each other is evident from the left region of the figure, while an activation sequence of the individual valves is evident from the right region of the figure. The intake valves preferably operate with a partial stroke, wherein the first intake valve is activated at a different time from that of the second intake valve. However, the two can overlap in their opening phase. Combustion chamber recirculation (BRR) and also advanced-intake closing (FES) are implemented by means of the interaction of the second intake valve with the exhaust valve. In BRR, the exhaust valve is preferably opened, wherein the second intake valve also opens during the opening phase of the exhaust valve. Reversing the opening motion of the second intake valve to a closing motion preferably takes place while the exhaust valve is even further along in its opening motion. In FES, the second intake valve is found in its closing motion while the first intake valve is still in its opening motion. Preferably, the opening motion has not yet completed when the closing motion of the second intake valve ends.

FIG. 16 shows, in a schematic view, another schematic for a 3-valve system on a cylinder with an intake valve EV, a first exhaust valve AV1, and a second exhaust valve AV2. Here, the exhaust valves are preferably actuated with partial stroke. While the first exhaust valve is used for BRR, the second exhaust valve is switched so that it opens when the intake valve is not yet closed and the first exhaust valve has already been closed for a long time during the closing motion of the intake valve. The second exhaust valve is opened again, which preferably takes place during an opening phase of the intake valve.

1. A reciprocating internal combustion engine (1) of a motor vehicle with a controller for the cyclical-synchronous and preferably cylinder-selective switching from spark ignition to controlled compression ignition and vice versa, wherein a valve group (8) of a cylinder has several intake and exhaust valves and an opening period of the valve group (8) is distributed differently to the intake and/or exhaust valves.

2. The reciprocating internal combustion engine (1) according to claim 1, characterized in that for valve overlap, an opening period of the valve group (8) is distributed differently to the intake and/or exhaust valves.

3. The reciprocating internal combustion engine (1) according to claim 1, characterized in that the intake valves of the valve group (8) each have a different opening period.

4. The reciprocating internal combustion engine (1) according to claim 1, characterized in that the exhaust valves of the valve group (8) each have a different opening period.

5. The reciprocating internal combustion engine (1) according to claim 1, characterized in that an opening time of a first intake valve of the valve group (8) deviates from an opening time of a second intake valve of the valve group (8) and an opening time of a first exhaust valve of the valve group (8) deviates from an opening time of a second exhaust valve of the valve group (8).

6. The reciprocating internal combustion engine (1) according to claim 5, characterized in that the first exhaust valve and/or the first intake valve of the valve group (8) are integrated in a switchable way into an internal exhaust-gas recirculation strategy, while the second exhaust valve and/or the second intake valve are linked to a combustion cycle.

7. The reciprocating internal combustion engine (1) according to claim 1, characterized in that this has at least one multiple-part camshaft (14), which has an inner shaft (17) with at least one cam profile that is adjustably arranged in an outer shaft (15) of the camshaft (14).

8. The reciprocating internal combustion engine (1) according to claim 7, characterized in that several cams of the camshaft (14) are adjustable for one valve.

9. The reciprocating internal combustion engine (1) according to claim 7, characterized in that the inner shaft (17) and outer shaft (15) are adjustable together and also relative to each other.

10. The reciprocating internal combustion engine (1) according to claim 1, characterized in that at least one mechanical switching element, which when activated causes a valve deactivation and/or a cyclical-synchronous switching between different combustion methods, is assigned to each cylinder (6).

11. The reciprocating internal combustion engine (1) according to claim 1, characterized in that the valve group (8) is coupled with an electromagnetic or electromechanical valve operating mechanism (7).

12. A method for cyclical-synchronous switching from a low to a high residual-gas content for simultaneous adjustment of an opening time of at least one intake valve and cylinder charging, wherein an opening period of a valve group (8) of a cylinder (6) with several intake and exhaust valves is distributed differently to the intake and/or exhaust valves of the valve group (8).

13. A method for the operation of a reciprocating internal combustion engine (1) of a motor vehicle, wherein a cyclical-synchronous switching from spark ignition to controlled compression ignition and vice versa is controlled, wherein an opening period of a valve group (8) of a cylinder (6) with several intake and exhaust valves is distributed differently to the intake and/or exhaust valves of the valve group (8).

14. The method according to claim 13, characterized in that the switching is performed in a cylinder-selective way.

15. The method according to claim 13, characterized in that at least one first cylinder is operated during at least several crankshaft rotations for controlled compression ignition, while at least one second cylinder is spark-ignited during the same time period.

16. The method according to claim 12, characterized in that one first and one second cylinder are switched simultaneously during a few crankshaft rotations.

17. The method according to claim 15, characterized in that when switching, all of the valves of a valve group (8) are deactivated apart from an exhaust valve and at least one intake valve.

18. The method according to claim 13, characterized in that for a low load between 0% and 60% of a nominal load, in particular, a load between 20% to 40%, a residual gas is retained in a combustion chamber in an amount of at least 20% to approximately 80% of a volume generated during a combustion process through a shortened opening period of at least one exhaust valve.

19. The method according to claim 18, characterized in that for a high load in a range between 0% and 80% or 75% and 100% of a nominal load, an opening period of an exhaust valve is adapted such that the residual gas pushed out of the combustion chamber is drawn back in.

20. The method according to claim 19, characterized in that an exhaust valve is reopened during a downward motion of a piston after completion of a first charge cycle.

21. The method according to claim 13, characterized in that a residual gas control is realized for a diesel engine through reopening of an exhaust valve, wherein, in particular, in the diesel engine a piston shape is used in interaction with the exhaust valve such that it manages without valve seat pockets.

22. The method according to claim 13, characterized in that a cyclical-synchronous switching is realized by means of a mechanically variable valve operating mechanism on at least one valve of a cylinder.

23. The method according to claim 22, characterized in that an advanced-intake closing and/or a retarded-intake closing is set by means of the mechanically variable valve operating mechanism.
